(19) United States
(12) Patent Application Publication
(10) Pub. No.: US 2015/0317585 A1
(43) Pub. Date: Nov. 5, 2015

(54) OPTIMAL WELLBORE PATH PLANNING

(71) Applicant: SCHLUMBERGER TECHNOLOGY CORPORATION, Sugar Land, TX (US)

(72) Inventors: Neilkunal PANCHAL, Dhahran (SA); James Ferris WHIDBORNE, Bedfordshire (GB); Martin Thomas BAYLISS, Stonehouse (GB); Maurice RINGER, Roissy-en-France (GB)

(21) Appl. No.: 14/652,013

(22) PCT Filed: Dec. 13, 2013
(86) PCT No.: PCT/IB2013/060921

§ 371 Date: Jun. 12, 2015

Related U.S. Application Data
(60) Provisional application No. 61/736,996, filed on Dec. 13, 2012.

(51) Int. Cl. G06Q 10/06; G06Q 50/06; G06F 17/10

(52) U.S. Cl. CPC G06Q 10/06313; G06F 17/10; G06Q 50/06

(57) ABSTRACT

Methods and systems for generating a well-plan with respect to geological targets. The well plan can be optimized for strain energy and torsion, to generate a smooth borehole. The resultant path can be constrained for curvature which is a design parameter and can produces a path feasible for a directional steering tool to achieve. The method can be constructed as a convex optimization problem, and/or provide a unique solution by interior point methods.

### BACKGROUND

Consumption of oil and gas serves more than half of the world's energy demand. Since the 1980s the rate of production of existing oil fields is increasingly greater than the rate of discovery of new reserves. To meet future energy demands, it will be necessary to drill for oil in more challenging oil reserves in more hostile environments. Rotary drilling systems are used to create boreholes to produce oil and gas from deep beneath the Earth's surface. Boreholes that are tail bored to maximize contact with oil/gas reservoirs increase the volume of production recovery.

Directional drilling is the process of creating boreholes by steering a drilling tool along a well-plan defined by a multidisciplinary team of: reservoir engineers; drilling engineers; geo-steerers; and geologists amongst others. Since their inception, rotary steerable systems (RSS), have enabled steering automation, with down-hole sensors, actuators, and processors close to the bit. This enables the drilling of longer reaching wells, and complex well geometries. Automation thus adds capability to the drilling process and is a value driver with the potential to reduce cost per foot of a well, and maximize production which can be recovered in a reservoir. Since oil and gas is a finite resource, reducing the cost per barrel is required to economically meet energy demand for the near future.

### BRIEF SUMMARY

Embodiments of the present invention are directed toward methods and systems for generating a well-plan with respect to geological targets. In certain aspects, the well plan may be optimized for strain energy and torsion, to generate a smooth borehole. The resultant path may be constrained for curvature, which may be used as a design parameter and to produce a feasible path for a directional steering tool to achieve. The method may in some aspects be constructed as a convex optimization problem, and/or provide a unique solution by interior point methods.

In some embodiments of the present disclosure, a method for generating a geological well-plan is provided in which an initial pose of the well is defined, a sequence of destinations is defined, steerability constraints of a drilling system for drilling the well are defined, a smoothness objective for the wellbore is set and an optimal well-plan from the initial pose to the first destination and then from destination to destination through the sequence of destinations is calculated, wherein the well-plan is calculated using the steerability constraint and the smoothness objective.

In some embodiments of the present disclosure, a system for designing a well-plan for a wellbore penetrating through an earth formation is provided, the system comprising a processor configured to receiving a start location and a goal in the earth formation and to execute instructions thereon, the instructions comprising:
determining a series of target locations between and including the start location and the goal;
configuring the well-plan between the start location and the goal, wherein:
   the configured well-plan passes through each of the target locations in the series of target locations;
   the configured well-plan is designed by processed sections of well-path between each of the series of targets;
   the sections of well-path are processed by calculating a starting curvature of the wellbore at a first of the series of targets and designing a curve section between the first of the series of targets and second of the series of targets, wherein a curvature of the curve section is minimized using the starting curvature and drilling characteristics of a drilling to be used to drill the wellbore as constraints; and
at least one of storing or outputting the designed well-plan.

In embodiments of the present invention, the smoothness of the wellbore being drilled is set as an objective to provide for reducing wear on the drilling system and providing for efficient casing of the wellbore prior to production of hydrocarbons from the wellbore. Casing comprises deploying a casing string in the wellbore. In some aspects, the properties of the casing string may be used to determine strain effects, torsional effects and/or friction on the casing string to be deployed in the wellbore. In other aspects, the wellbore itself may be considered to have inherent strain effects, torsional effects and/or frictional effects.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 shows a block diagram of a trajectory work flow, in accordance with an embodiment of the present invention.

FIG. 2A shows a representation of space curves used for the well plan that can be in the form of uniform B-splines, in accordance with an embodiment of the present invention.

FIG. 2B shows an example of a position constraint, in accordance with an embodiment of the present invention

FIG. 2C shows an example of a position constraint, in accordance with an embodiment of the present invention.

FIG. 3 shows an example of a set of basis functions, in accordance with an embodiment of the present invention.

FIG. 4A shows an example of a target point within an ellipsoid, in accordance with an embodiment of the present invention.

FIG. 4B shows an example of a target point in a plane, in accordance with an embodiment of the present invention.

FIG. 5 shows a generalized sequence of target constraints, in accordance with an embodiment of the present invention.

FIG. 6 shows an example of lease line constraints, in accordance with an embodiment of the present invention.

FIG. 7 shows an example well plans created for an initial pose of vertical to hit a target at a given attitude, in accordance with an embodiment of the present invention.

FIG. 8 shows another example of well plans created for an initial pose of vertical to hit a target at a given attitude, in accordance with an embodiment of the present invention.

FIG. 9 shows the effect of the constraints on the curvature, in accordance with an embodiment of the present invention.

FIG. 10 takes the final position and attitude of the prior well plan to use as an initial pose for the next stage, in accordance with an embodiment of the present invention.

FIG. 11 shows simulated strain energy curves, in accordance with an embodiment of the present invention.

FIG. 12 shows the curvature along the well-plans, in accordance with an embodiment of the present invention.

FIG. 13 shows an example of a computational system that can be used to perform some embodiments of the invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. Code and/or processor instructions may comprise non-transient signals that may be stored and used to operate the methods of some embodiments of the present invention.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Embodiments of the invention are directed toward methods and/or systems for controlling the trajectory of a well bore for the extraction of hydrocarbons from an oil reservoir. In some aspects, a path planning problem is considered with respect to geology based on B-splines and convex optimizations.

Minimizing strain energy for a well-plan can minimize energy lost in bending and twisting the drill-pipe in the borehole during drilling. This energy minimization reduces the contact forces and hence friction between the drill string and the formation in which the borehole is being drilled and can provide better weight and torque transfer to the bit. The energy minimization can also have implications for extended reach drilling. Furthermore, designing smoother well-plans reduces the risk of mechanical failure from bending moments acting on drill-pipe sections in the borehole.

Some embodiments include a workflow for generating a well plan based on optimizing B-splines. In embodiments of the present invention, constraints may be used that represent features, which are important in the well-planning operations. The technique in accordance with an embodiment of the present invention may allow for rapid generation of well-plans that are smooth. In some aspects, a method for handling attitude constraints, which is independent of magnitude and gives a unique attitude solution, is provided. In some embodiments, curvature constraints are handled for space curves and used for generating feasible well-plans. Moreover, a workflow in accordance with an embodiment of the present invention has been tested in a simulation and provided minimized strain energy.

Some embodiments of the invention are directed toward methods and/or systems that are designed to create a well-plan that satisfies the following conditions:

1. The well intersects a sequence of predefined targets.

2. The well can be drilled and/or tracked with a directional drilling tool.

3. The well is continuous, smooth, and/or satisfies some fairness criteria.

4. The well plan includes prior information about the performance of a drilling tool in subspaces of the reservoir.

The main reason for drilling a well/borehole is to reach a strategic target(s) in a hydrocarbon reservoir. Targets are regions, such as volumes of high hydrocarbon saturation, through which the well-plan must pass. In embodiments of the present invention, these targets may be treated as constraints in a well-plan. In embodiments of the present invention, the curvature performance of a drilling tool may be treated as a constraint, which constraint may be limited to the choice of steering assembly and may vary in different regions in the reservoir, where the different regions may have different geotechnical properties and may change the curvature performance. In embodiments of the present invention, when designing a well-plan in a reservoir, prior information from the performance of earlier drilled wells can provide estimates of the curvature capability.

The steerability constraint may represent the maximum curvature of a drilling tool. Factors affecting the curvature of a well-plan include the bottomhole assembly (BHA) used in the drilling process and/or geology of the formation being drilled. For the former, the curvature of the drilling tool can depend on the type of steering assembly used, the choice of bit, the location of stabilizers, and the stiffness of the drill collars. For the latter, the nature of the bedding planes and the pressures, densities and fluids in the reservoir will affect the steering capability. The curvature capability may be estimated by a drilling engineer from experience of the drilling performance of BHA's in nearby or similar wells.

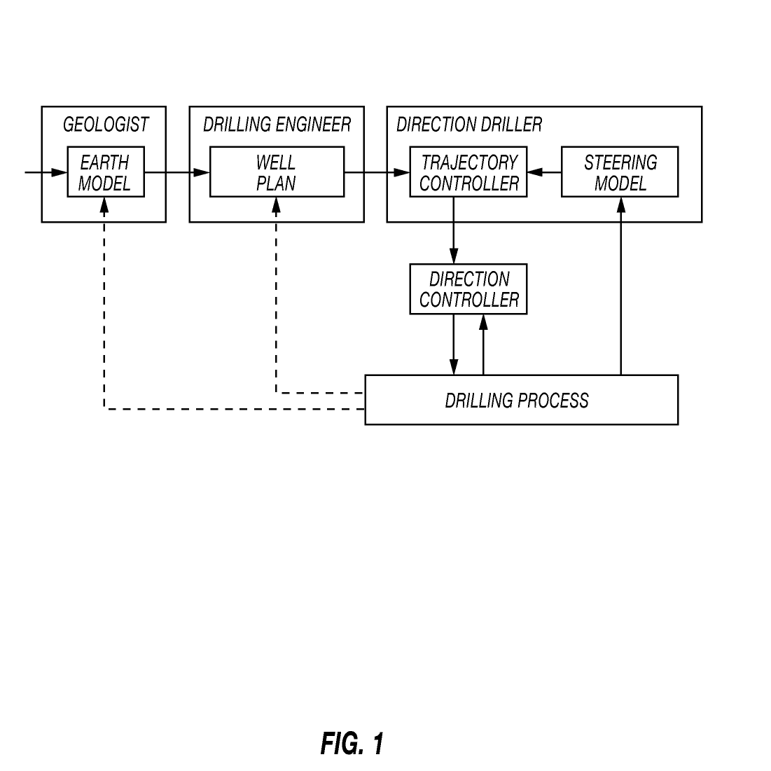

B-spline space curves may be used to represent a well-plan in a hydrocarbon reservoir to define a path for steering a directional drilling tool. The B-spline space curve technique can provide the definition of the reference path for a trajectory. Moreover, well-planning optimization may be extended to dynamically generate real-time paths. Well planning interfaces the overall system (See FIG. 1) as the objectives and constraints are defined with respect to an Earth model and drilling strategy.

The well-planning workflow as shown in FIG. 1, in accordance with an embodiment of the present invention, can be used to determine an optimum well-plan between an initial configuration and a destination. In embodiments of the present invention, the properties of the optimum curve at the destination serves as an initial configuration for the next segment of the well-plan to the next destination. In embodiments of the present invention, this process is repeated until all the destinations are exhausted. In some aspects, curvature constraints and smoothness objectives may be user-defined between each initial configuration and destination. In other aspects, a processor may be used to process optimal and/or preferred curvature constraints and/or smoothness objectives The result is a continuous well-plan from the initial configuration through all the targets.

The drill-string is subject to bending moments from the borehole when being tripped in (run into the borehole), and when tripped-out (removed from the borehole). As such, may be helpful for the well-plan to be smooth so as to minimize friction due to bending on the drill string. Friction reduces the possible length of the borehole as friction reduces the energy transferred from the surface to the bit for the rock destruction process. Bending moments on the drill-string cause fatigue on the connections between drill-pipe stands and is a cause for mechanical failure. These smoothness criteria can also be important after drilling when the well/borehole is cased. Casing is a process where a casing string is used to line the borehole. Casing is tripped-in with tubulars being stiffer and of a larger diameter than the drill-string. As a result, the casing string is subject to greater bending moments and friction than the drill string.

The smoothness of a well-plan may be presented in terms of its tortuosity. However, there is no standard in the drilling industry for defining tortuosity. The tortuosity for a general pipe in terms of the curvature and the torsion can be determined. Moreover, a two dimensional extension for using strain energy for defining tortuosity can be determined where the strain energy is weighted more for the borehole at locations close to the surface. In addition, factors such as the clearance of the hole may be considered in a strain energy model.

Lease-lines may impose a contractually defined constraint that defines where the wellbore must not cross. If during the drilling process, a lease line is crossed, fines may result as the boundary of the lease defines the property. Furthermore, anti-collision constraints may need to be considered with respect to existing wells that exist in the reservoir.

In embodiments of the present invention, interior point methods may be used to provide optimization of the minimum strain energy. In some aspects, the well-plan problem may be constructed as a convex optimization in order to exploit the benefits of the speed and uniqueness of solutions in this method. In some embodiments of the present invention, spline may be used to interpolate start and end positions and attitudes. The splines can then be optimized for minimum strain energy and an analytical solution provided.

In some aspects, the minimum curvature method may be used for constructing well-plans. The minimum curvature method is based on trigonometric calculations of fitting circles and straight line segments to hit targets and planes. In embodiments of the present invention, an extension to this minimum curvature method for planning wells for extended reach is provided where the interface between the circle section of the well plan and the straight line segment is interfaced with a clothoid curve.

One advantage of embodiments of the invention includes the ability to plan well-plans with respect to constraints while simultaneously minimizing strain energy torsion and/or arc length. Furthermore, a variety of constraints can be defined and the result is a continuous curve where drilling parameters such as tool face, inclination, and azimuth can be easily extracted.

In some embodiments, a high-level workflow for constructing a well-plan with respect to constraints is provided. In embodiments of the present invention, the overall well-plan is broken down into smaller well-plans between a series of intermediate starting configurations and intermediate targets and the resultant well-plan is a concatenation of these smaller well-plans. One advantage of this workflow is that objectives and/or constraints can be tailored to subsections of the well-plan. In some embodiments, the well-planning is constructed to be a convex optimization problem.

In some embodiments, a pose M is used where the pose M is defined as the combination of the position and orientation of the drill string and/or a portion of the drill string at a point. In some embodiments, a destination D may be defined as a pose within a closed neighborhood about its position, where this neighborhood is a convex set.

In some embodiments, the solution workflow is shown in the following algorithm (Algorithm 1):

1: Define initial pose M₀ to be where the well-plan begins

2: Define a sequence of destinations Dᵢ, i=0 . . . iₙ

3: Set steerability constraints

4: Set smoothness objectives

5: Set i=0

6: while i<iₙ do

7: Solve for optimal well-plan yᵢ from Mi to Dᵢ

8: i=i+1

9: Set Mᵢ₊₁ equal to the pose with normal of y in Di.

10: end while

11: concatenate the vector well-plans y={yᵢ}=0

In some embodiments, the solution of the optimal well-plan from M, to D, can be constructed to be in the form of a convex optimization problem. One advantage of forming the problem in this way is that for a convex optimization problem, if a solution exists, the local minimum is the global minimum. In addition fast accurate methods such as interior point and active set methods can be used to solve the problem. The form of the primal optimization for the well-planning problem can be:

Minimize f₀(y) i=1, . . . , m (3.1)

subject to fᵢ≦0 i=1, . . . ,m (3.2)

hⱼ(y)=0 (3.3)

where f₀(y) is the objective function to be minimized, fᵢ are general convex inequality constraints, and hⱼ(y) are equality constraints. Then the Lagrangian L(y, λ, ν) of the primal problem can be defined as:

L(y,λ,v)=f₀(y)+Σᵢ₌₁^{m}λᵢfᵢ(y)+Σᵢ₌₁^{j}vᵢhᵢ(y) (3.4)

where λᵢ≧0, and called the dual variables. Define the dual function to be

g(λ,ν)=inf_{y}L(y,λ,ν). (3.5)

The dual function g(λ,ν) has the property of being concave even if L(y, λ, ν) is not convex. Let the minimum value of the primal problem be y=y*, and the maximum of the dual be λ=λ*.

According to Slaters Condition, if a primal problem has a strictly feasible y and is convex with

fᵢ≧0 i=0, . . . m (3.6)

hⱼ(y)=0 j=1, . . . p (3.7)

then the minimum of the primal problem is equal to the maximum of the dual y*=λ*.

The following KKT Conditions can be defined:

fᵢ(y*)≦0 i=i, . . . m (3.8)

hⱼ(y*)=0 j=1, . . . p (3.9)

λᵢ*≧0 (3.10)

λᵢ*fᵢ(y*)≧0 (3.11)

∇f₀(y*)+Σᵢ₌₁^{m}λᵢ*∇fᵢ(y*)Σᵢ₌₁^{j}νᵢ*∇hᵢ(y*) (3.12)

When Slaters condition holds, the KKT conditions are necessary and provide sufficient conditions for optimality.

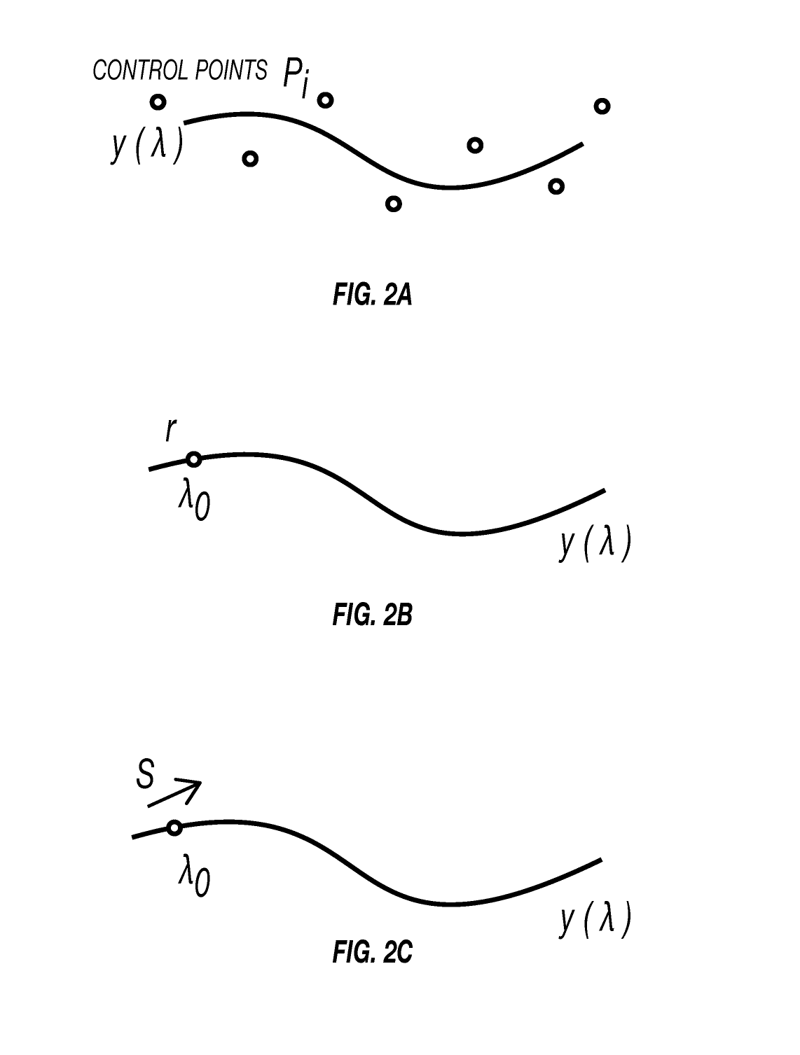

In some embodiments, the representation for the space curves used for the well plan can be in the form of uniform B-splines as shown in FIG. 2A. A piecewise space-curve y(λ)ε [symbol] ³ with respect to a parameter λε [symbol] ⁺ may be represented as a uniform B-spline.

y(λ)=Σᵢ₌₀^{m+d-1}PᵢNᵢ^{d}(λ). (3.13)

The point-wise sequence of the control points Pᵢε [symbol] ³ give a polyhedron, which is a convex hull whose volume encloses the resultant curve y(λ). As shown in the figure, the curve y(λ) does not interpolate the control points Pᵢ but is an affine combination of its control points where the affine combination is determined by the choice of basis function Nᵢ^{d}(λ)ε [symbol] ⁺.

B-spline curves Nᵢ^{d}(λ)ε [symbol] are polynomial basis functions of order d. The B-spline basis Nᵢ^{d}(λ) has a property of local-support, that is to say that N(λ) is non-zero for a fixed range of λ, where for a given order d, the curve y(λ) will be a combination of d+1 adjacent control points. The B-spline basis is defined by the De-Boor recursion:

$$\begin{matrix}{N}_{i}^{d} ( λ ) = \frac{λ - i + 1}{d} {N}_{i}^{d + 1} ( λ ) + \frac{i + d - λ}{d} {N}_{i + 1}^{d - 1} ( λ ) & ( 3.14 ) \\ {N}_{i}^{0} ( λ ) = \{ \begin{matrix}1 , & if i - 1 \leq λ < i \\ 0 , & otherwise\end{matrix} . & ( 3.15 )\end{matrix}$$

The curve y(λ) contains mε [symbol] segments, and is defined in the domain λε[d−1, m+d−1] where dεN is the degree of the B-spline polynomial basis. B-spline curves have the property of partition of unity, that is to say

Σᵢ₌₀^{m+d-1}Nᵢ^{d}(λ)=1. (3.16)

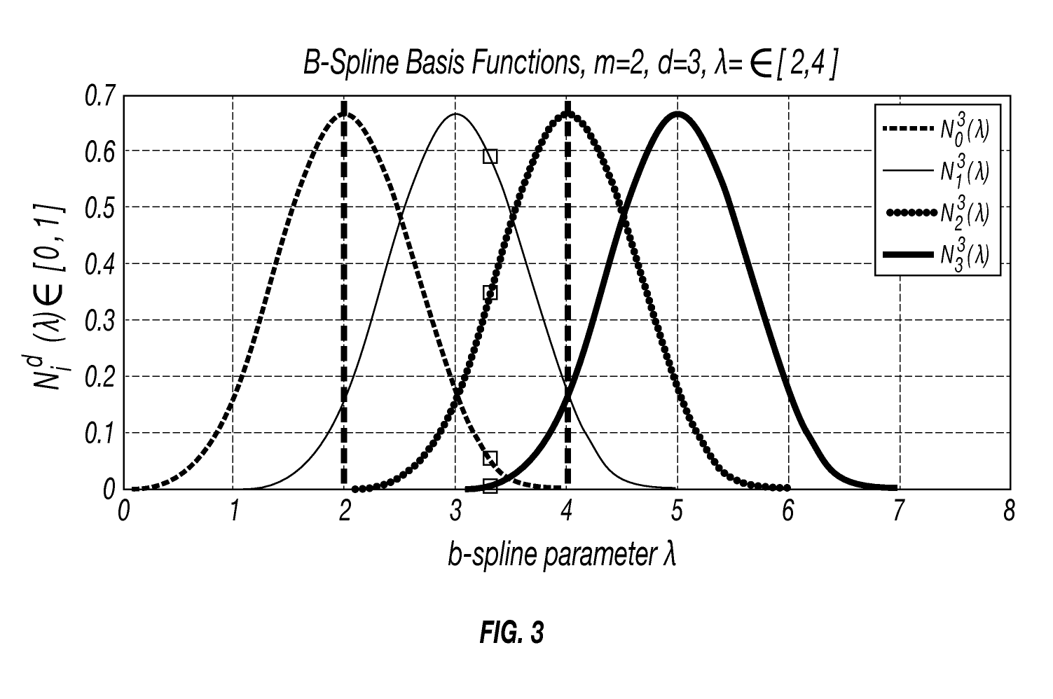

The set of basis functions are shown in FIG. 3 for a cubic B-spline of degree d=3 for m=2 segments for the range λε[2, 4]. For the case where λ=3.3, the values for the corresponding bases are outlined by square markers, and it is the case that these sum to unity. The B-splines here are uniform with the spacing of each segment corresponding to an addition of λ by unity. It is also the case that each basis function is a translation by λ.

A B-spline space curve is C^{d-1} continuous, and for the case of a cubic spline it can have continuous first and second derivatives. Furthermore the tangent and normal to a curve can also be linear in their control points. The tangent to this curve t(λ)ε [symbol] ³ is given in terms of its control points by

$$t ( λ ) = {\sum }_{i = 0}^{m + d - 1} {P}_{i} \frac{d {N}_{i}^{d} ( λ )}{d λ} . \qquad ( 3.17 )$$

Since the control points are fixed, only the derivative of the basis needs to be considered.

The derivative can be found to be

$$\frac{d {N}_{i}^{d} ( λ )}{d λ} = d ( {N}_{i}^{d - 1} ( λ ) - {N}_{i + 1}^{d - 1} ( λ ) ) , \qquad ( 3.18 )$$

where

$$\frac{d {N}_{i}^{d} ( λ )}{d λ}$$

is the basis for the tangent and is expressed in terms of the De-Boor relations equation (3.14). Similarly, the normal to the curve y(λ) at λ can be found by replacing the first derivative term in equation (3.17) with a second derivative term and differentiating equation (3.17). Throughout this disclosure, examples of embodiments of the invention will be described using a well-plan represented as cubic B-splines where d=3. This is the minimum order to have continuous second derivatives on the curve y(λ). Various other B-splines can be used without limitation.

The resultant well-plan may satisfy the smoothness criteria. It can be desirable for the well-plan to minimize the bending and twisting by the borehole on tubulars. It can also be undesirable for well-plans to be unnecessarily large. The objective functions can use approximations of: stretch; strain; and twist energy, for determining the control points. The objective function can be defined in terms of the arc length minimizer Eₗ, the bend energy E_{c} and the torsion Eᵢ:

Eₚᵢₚₑ=α₁Eₗ+α₂E_{c}+α₃Eₜ (3.20)

where

$$\begin{matrix}{E}_{l} = {\int }_{d - 1}^{m + d - 1} {\vert \frac{d y ( λ )}{d λ} \vert}_{2}^{2} d λ & ( 3.21 ) \\ {E}_{c} = {\int }_{d - 1}^{m + d - 1} {\vert \frac{{d}^{2} y ( λ )}{d {λ}^{2}} \vert}_{2}^{2} d λ & ( 3.22 ) \\ {E}_{t} = {\int }_{d - 1}^{m + d - 1} {\vert \frac{{d}^{3} y ( λ )}{d {λ}^{3}} \vert}_{2}^{2} d λ . & ( 3.23 )\end{matrix}$$

Using the local support property, a curve y(λ) defined on the k^{th} segment λε[2+k, 3+k] is written as

yₖ(λ)=τᵢ₌₀³Pᵢ₊ₖNᵢ₊ₖ³(λ). (3.24)

Since the derivatives on y(λ) with respect to λ act only on the basis function N(λ) and not the control points, the energy for the pipe Eₚᵢₚₑ can be written as a quadratic form in the control points Pᵢ₊ₖ as

$${E}_{pipe}^{k} = {\sum }_{i = 0}^{3} {P}_{i}^{T} {Q}_{ij}^{k} {P}_{j} , \qquad ( 3.25 )$$

with

Q^{k}=α₁Qₗ^{k}+α₂Q_{c}^{k}+α₃Qᵢ^{k}. (3.26)

The symmetric positive definite matrices Q^{k}, Qₗ^{k}, Q_{c}^{k}, Qᵢ^{k} can be found where:

$$\begin{matrix}\begin{matrix}{Q}_{l}^{k} = {\int }_{2 + k}^{3 + k} \frac{d {N}_{i + k}^{3} ( λ )}{d λ} \frac{d {N}_{j + k}^{3} ( λ )}{d λ} d λ \\ = \frac{1}{120} ( \begin{matrix}6 & 7 & - 12 & - 1 \\ 7 & 34 & - 29 & - 12 \\ - 12 & - 29 & 34 & 7 \\ - 1 & - 12 & 7 & 6\end{matrix} ) ( 3.28 )\end{matrix} & ( 3.27 ) \\ \begin{matrix}{Q}_{c}^{k} = {\int }_{2 + k}^{3 + k} \frac{{d}^{2} {N}_{i + k}^{3} ( λ )}{d {λ}^{2}} \frac{{d}^{2} {N}_{j + k}^{3} ( λ )}{d {λ}^{2}} d λ \\ = \frac{1}{6} ( \begin{matrix}2 & - 3 & 0 & 1 \\ - 3 & 6 & - 3 & 0 \\ 0 & - 3 & 6 & - 3 \\ 1 & 0 & - 3 & 2\end{matrix} ) ( 3.30 )\end{matrix} & ( 3.29 ) \\ \begin{matrix}{Q}_{t}^{k} = {\int }_{2 + k}^{3 + k} \frac{{d}^{3} {N}_{i + k}^{3} ( {λ}^{3} )}{d {λ}^{3}} \frac{{d}^{3} {N}_{j + k}^{3} ( λ )}{d {λ}^{3}} d λ \\ = ( \begin{matrix}1 & - 3 & 3 & - 1 \\ - 3 & 9 & - 9 & 3 \\ 3 & - 9 & 9 & - 3 \\ - 1 & 3 & - 3 & 1\end{matrix} ) ( 3.32 )\end{matrix} & ( 3.31 )\end{matrix}$$

The total energy along Eₚᵢₚₑ is the sum of Eₚᵢₚₑ^{k} for all segments k. The corresponding symmetric positive definite matrix Q can be constructed by representing the energy as

Epipe=p^{T}Qp. (3.33)

The 1×3(m+d) vector p is the concatenation of the 3×(m+d) control points Pᵢ. The matrix Q can be found using the following algorithm:
1: construct Q a (m+d)×(m+d) matrix with zero entries,
2: add the matrix Q^{k} into Q such that Q_{1 . . . 4,1 . . . 4}=Q_{1 . . . 4,1 . . . 4}^{k}.
3: Continue adding Q_{1 . . . 4,1 . . . 4}^{k} along the diagonal of Q beginning with Q_{i . . . i+3,i . . . i+3} with i=2 until i=m+d−3.
4: replace each entry in q_{i,j}εQ with q_{i,j}I_{3×3}ε [symbol] is the identity matrix. The result is a 3(m+d)×3(m+d) matrix Q=0.

In some embodiments, constraints for the well-planning optimization may be considered. The constraints consider the representation of: the initial pose of a well-plan section, destinations (as described in Algorithm 1 (above)), steerability, lease-lines, and anti-collision. Before proceeding, however, in some aspects, a modified expression for y(λ) may be defined for the constraints to be in terms of the concatenated control points p.

Let \hat{N}ᵢ={Nᵢ^{d}(λ₀)} be the 1×(m+d) vector for the basis function N for a constant λ₀. Now replace each term \hat{N}ᵢ→\hat{N}ᵢI_{3×3} by the same term multiplied by the identity matrix. The result is a 3(m+d)×3 matrix N(λ). Now the equation for the curve can be written in terms of the concatenated control points p

y(λ)=N(λ)p. (3.34)

Similarly for the tangent and binomial

t(λ)=N′(λ)p (3.35)

b(λ)=N″(λ)p. (3.36)

An example of a position constraint is shown in FIG. 2B. A position constraint is a position and/or point where well must pass. Let rε [symbol] ³ be a point in the reservoir which the resultant well-plan y(λ) must pass for a specified parameter along the well-plan λ₀. Since λ₀ can be specified, then the bases Nᵢ^{d}(λ) can have constant values and r can be written as a constant linear combination of the control points P:

r=N(λ₀)p, (3.37)

An example of a position constraint is shown in FIG. 2C. Let sε [symbol] ³ be a tangent direction where the magnitude may be of interest at a specified parameter λ₀ along the resultant curve y(λ). The equation for the constraint can be:

s=N′(λ₀)p. (3.38)

Specifying the magnitude of the direction may have undesirable effects as this imposes a spacing between the control points. In some embodiments the constraint can be written in terms of the cross product of s×y′(λ₀). Although for most cases this gives pleasing results, this method allows for the tangent to be in the opposite direction to y′. A solution to this problem can include a dummy variable y in the objective function, with an additional constraint on y>0 so that the modified equation (3.38) is:

sy=N′(λ₀)p, (3.39)

and the optimization problem containing this appears with the terms:

$$\begin{matrix}{minimized}_{p} y & \\ subject to & \begin{matrix}{N}^{′} ( {λ}_{0} ) p = s y \\ y > 0\end{matrix}\end{matrix} \qquad ( 3.40 )$$

since equations (3.37) and (3.38) are linear in the control points p, they can be combined into one matrix equality constraint

Cp=q. (3.41)

where q is a vector concatenation of the positions and tangents and C is the corresponding matrix concatenation of the basis.

When providing constraints on the destination, an ellipsoid constrain can be used for volumes in the reservoir with which it is desired for the well-plan to intersect. By giving a volume there is freedom for an optimization process to determine the most optimum location in the volume to place the well. In some embodiments, point in plane constraints can be used for modeling geological faults. Furthermore, in some aspects, at a single point at the end of a well-path subdivision, a combination of these constraints can be specified.

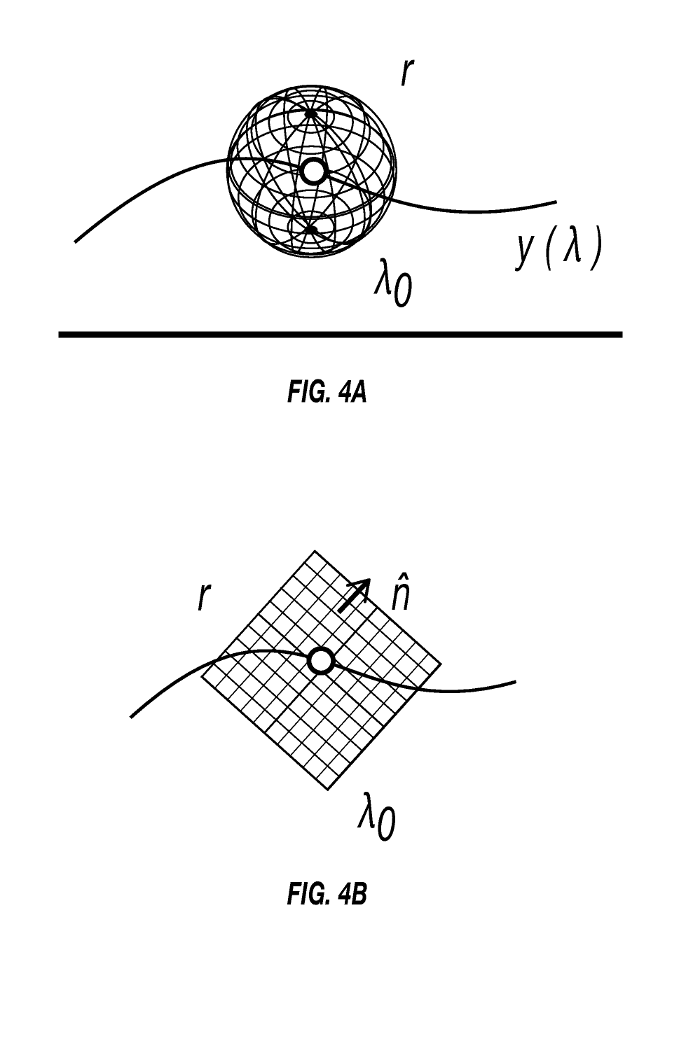

The general equation of an ellipsoid constraint as shown in FIG. 4A for a point on the well plan y(λ₀) for a specified parameter λ₀ to be enclosed in an ellipsoid about a given position r is:

(y(λ₀)−r)^{T}R^{T}Π⁻¹R(y(λ₀)−r)≦1, (3.42)

where the rotation matrix R is an orthogonal matrix of eigenvectors of the principal axis of the ellipsoid, and the diagonal matrix Π=diag(a², b², c²) contains the corresponding eigenvalues which represent the semi-major and semi-minor axis lengths. By substituting y(λ)=N(λ)p into equation (3.42), this constraint can be written as a convex quadratic inequality constraint:

p^{T}Ap+B^{T}p+c≦d². (3.43)

In the special case of a sphere, A=I_{3×3}, B=−2N(λ+0)p, c=r^{T}r and d is the radius of the sphere.

FIG. 4B shows an example of a plane constraint. A point in the plane may be specified by (N(λ₀)P−r)·\hat{n}=0, where r is a point in the plane and n is normal to the plane. This gives a scalar equality constraint of the form:

\hat{n}·N(λ₀)p=\hat{n}·r (3.44)

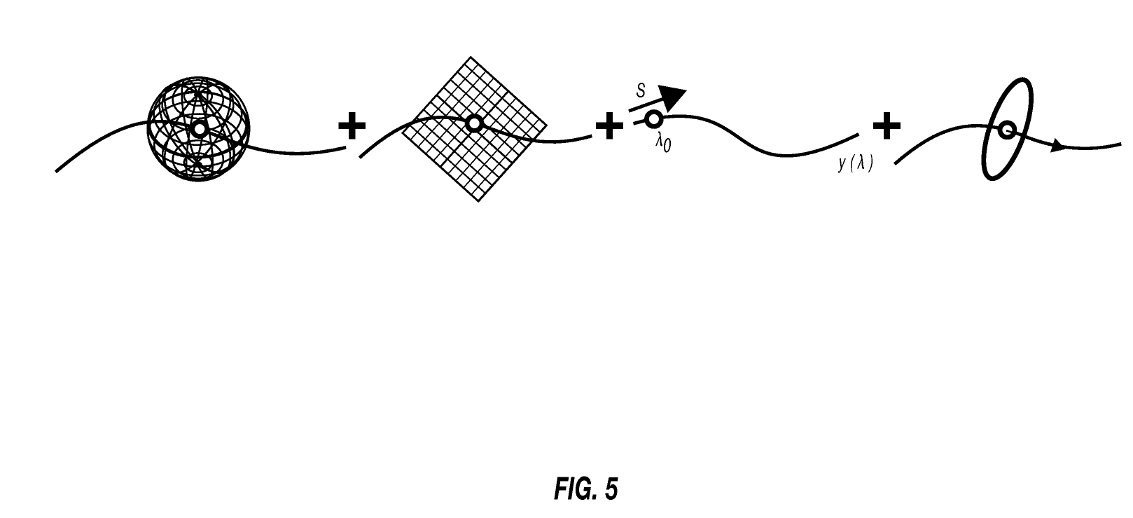

As shown in FIG. 5, in an embodiment of the present invention, a target constraint can be defined to be a combination of a point in ellipsoid, a point in plane, and a tangent constraint. The combination of a point in plane and a point in ellipsoid gives the intersection of an ellipsoid and a plane, which is an ellipse. The addition of the tangent constraint, in aspects of the present invention, for a specified λ, provides the interpretation of requiring the end of a well-path subsection to hit a disk at a given attitude. This attitude need not be normal to the ellipse, but, this may be the case if a known fault exists, and it is desired to drill through the fault at a given attitude. Other forms of tangent constraints may be constructed, provided they form convex sets.

In an embodiment of the present invention, anti-collision and lease lines can also be considered in the well-plan. The convex hull property of B-splines states that the control points {Pᵢ}define a polyhedron which the resultant curve y(λ) is enclosed by. In an embodiment of the present invention, the constraints for lease lines and anti-collision are in the form of convex volumes enclosing the control points. These constraints can be imposed over large sections of the well-plan. For Lease lines, these constraints are imposed over the entire well-plan. In embodiments of the present invention, the constraints do not involve the basis functions and/or may be imposed only on the control points.

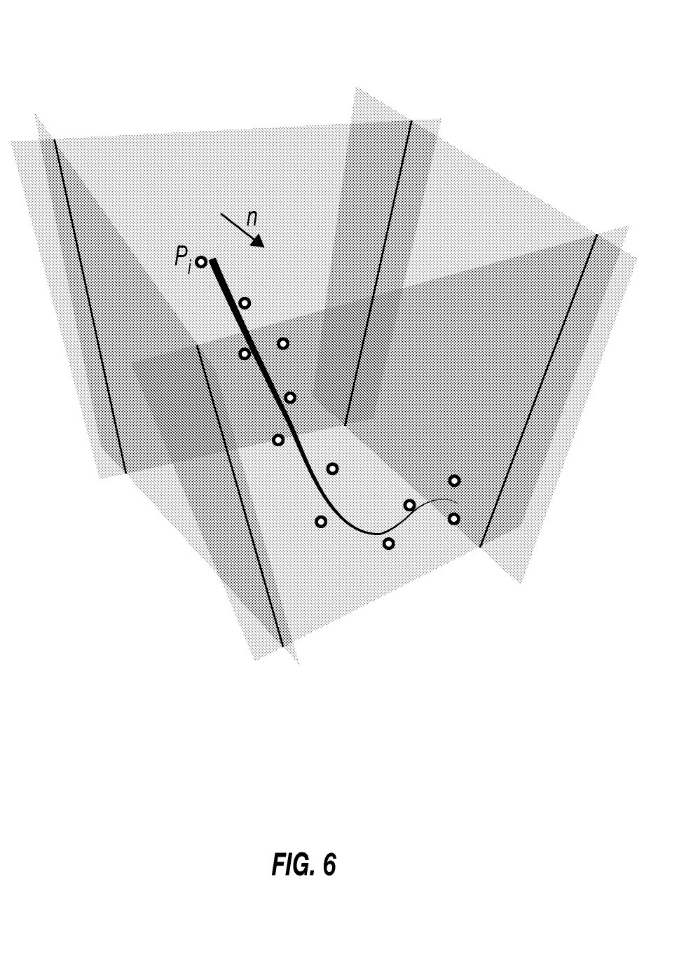

FIG. 6 shows an example of lease line constraints. Lease lines are contractual boundaries of the area of land of the owner of the exploration rights. In embodiments of the present invention, lease lines can be represented simply as inequality constraints on the control points Pᵢ. The inequality constraints are in the form of planes as shown in FIG. 6.

Given an arbitrary known position aε [symbol] ³ on a lease plane with normal vector \hat{n}, the inequality constraint for each control point Pᵢ can be given by

Pᵢ\hat{n}≧a\hat{n}. (3.45)

Lease line constraints can be expressed multiple times for each boundary provided that the enclosed volume is convex.

It is undesirable for a borehole to intersect existing wells. Wells are planned to avoid this catastrophe. In embodiments of the present invention, inequality constraints on the control points to restrict the solution space can be one method to ensure a resultant curve does not intersect an existing well. When solving for a well-plan between an initial pose and a destination, volume constraints in the form of multiple plane inequality constraints can restrict the solution space of the resultant curve.

In some embodiments steerability constraints may also be considered. The expression for the curvature (λ) of a curve y(λ) is given by:

$$κ ( λ ) = \frac{\vert {y}^{′} ( λ ) \times {y}^{″} ( λ ) \vert}{{\vert {y}^{′} ( λ ) \vert}^{3}} , \qquad ( 3.46 )$$

The curvature κ is approximated by

$$\frac{{d}^{2} y ( λ )}{d {λ}^{2}} .$$

For a unit speed |y′(λ)=1 arclength parameterized curve y(λ), the curvature is always equal to this value. For B-spline curves the parameterization will depend on the number of segments m, and the location since the constraint can be expressed as a convex inequality constraint and can be chosen to vary along the well-plan. This constraint will be expressed point-wise along a well-plan equally spaced along the parameter λ. The curvature constraint is given by:

$$\vert \frac{{d}^{2} y}{d {λ}^{2}} ( λ ) \vert \leq \overline{κ} , \qquad ( 3.47 )$$

where κ̅ is a scalar upper bound which constrains the curvature. Written in terms of B-splines, the inequality constraint can be expressed as:

p^{T}N″(λ)^{T}N″(λ)p≦R. (3.48)

Since the integrand of equation 3.48 is a Gram-Matrix, it is positive definite, and can form a convex quadratic constraint. Equation 3.48 is a relaxation on the curvature capability of the drilling tool. Later, an outerloop may be detailed in order to constrain the absolute curvature.

In some embodiments the path-planning problem can be a quadratically constrained quadratic program (QCQP). The QCQP involves a relaxation on the curvature constraint. This can include an outerloop hueristic on the parameter K to give an absolute curvature constraint which is practical for drilling applications.

In some embodiments the overall well planning problem can be presented as an optimization problem of the following equation:

$${minimize}_{p} {β}_{1} {p}^{T} Q p + {β}_{2} ( {y}_{1} + {y}_{2} ) \\ subject to \\ Fixed point constraints \text{:} \begin{matrix}N ( d - 1 ) p = {p}_{0} \\ {N}^{′} ( d - 1 ) p = {t}_{0} {y}_{1}\end{matrix} \\ Destination constraints \text{:} \begin{matrix}{N}^{′} ( m ) p = {t}_{d} {y}_{2} \\ \hat{n} \cdot N ( m ) p = \hat{n} \cdot r \\ {p}^{T} A p + {B}^{T} p + c \leq {d}^{2}\end{matrix} \\ Curvature constraints \text{:} {p}^{T} {{N}^{″} ( \frac{i}{d} )}^{T} {N}^{″} ( \frac{i}{d} ) p \leq R \\ Lease line constraints \text{:} \begin{matrix}{P}_{j} \cdot {\hat{n}}_{k} \geq {a}_{k} \cdot {\hat{n}}_{k} . \\ i = 2 d , … , m d . \\ j = 1 , … , m + d \\ k = 1 , … , {k}_{p}\end{matrix} \qquad ( 3.49 )$$

In the path-planning problem, the weights β₁+β₂=1. Since Qᵢ are real positive definite symmetric matrices, there is a convex quadratic cost with linear equality constraints and convex quadratic inequality constraints. The structure of this problem is a quadratically constrained quadratic program, where the inequality constraints are convex. If feasible, a unique solution can be found from interior point methods.

As presented above, the curvature constraint was an approximation. In embodiments of the present invention, an algorithm may be used where given an absolute curvature constraint for a well-plan κₘₐₓ, the well-plan planning problem is resolved by modifying κ̅ until the curve y defined by the control points p satisfies the constraint. This is done by solving the unconstrained problem to find a value for κ̅, and then performing a line search by reducing κ̅ until the constraint is met.

The well-planning technique according to embodiments of the present invention has been tested in a simulation based on the work-flow outlined in Algorithm 1. As described here, the coordinate system is chosen to be with the z-axis negative down-hole, and the x-axis positive due north. This chosen coordinate system may be mapped to other conventions by simple coordinate transformations. As described here, the curvature is measured in degrees per 100 ft, and the distances are measured in meters. The destinations Dᵢ and the initial pose M₀ is shown in Table 1.

TABLE 1
Destinations

| | Position | Attitude | Inclination | Azimuth |
|---|---|---|---|---|
| M₀ | (0, 0, 0) | (0, 0, −1) | 0 | 0 |
| D₁ | (500, 500, −600) | (1, 1, 0.2) | 45 | 111.3 |
| D₂ | (700, 700, −600) | (0.97, 0.23, 0) | −13.5 | 90 |

The initial stage M₀ is taken to be a point on a vertical well where the well plan begins to deviate. This is known as a kick-off-point (KOP). The first destination D₁ is chosen to represent a point with an associated attitude in the reservoir where the well is chosen to land. This point is chosen to have an extreme inclination of 111.3∘. The simulation can be run in two stages: from M₀ to D₁, and then by taking the position, attitude and normal at the end of this section of the well as an initial pose M for the second stage, M₂ to D₂.

The simulation in the first stage is designed to demonstrate the effect of changing the weights in the objective function. Two cases are run here: a bias towards minimizing arc-length a₁=0.9, a₂=0.1; and a bias towards minimizing strain energy a₁=0.1, a₂=0.9. This stage of the simulation is further designed to demonstrate the effect of enforcing an absolute curvature constraint of: 4°, 6°, and 8°∘/100 ft.

The second stage of is chosen to demonstrate the effect of an inequality disk constraint, where a disk centered around the position of D₂ as shown in Table 1 (above) or radii of 10, 20, 30 meters is chosen. In addition, the resultant curve is required to hit a plane normal to the attitude of D₂ in Table 1, where on striking this plane, the direction is also of this attitude.

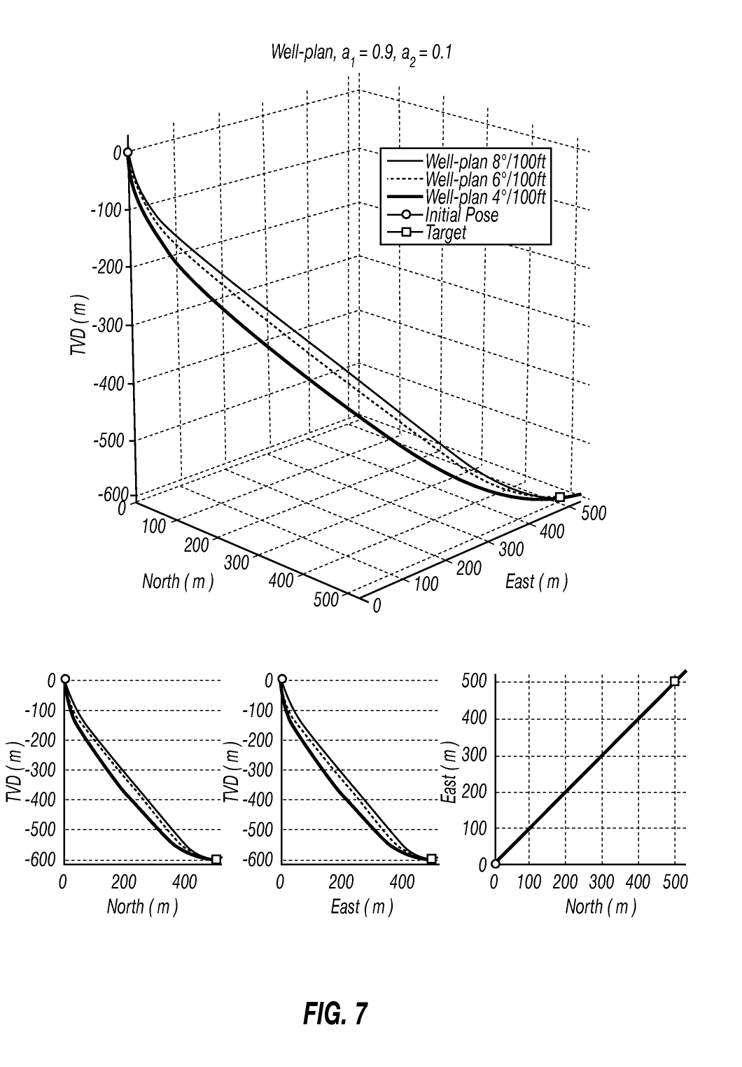

FIG. 7 shows the well plans created, in accordance with an embodiment of the present invention, for an initial pose of vertical to hit a target at a given attitude. Three different dogleg constraints were used.

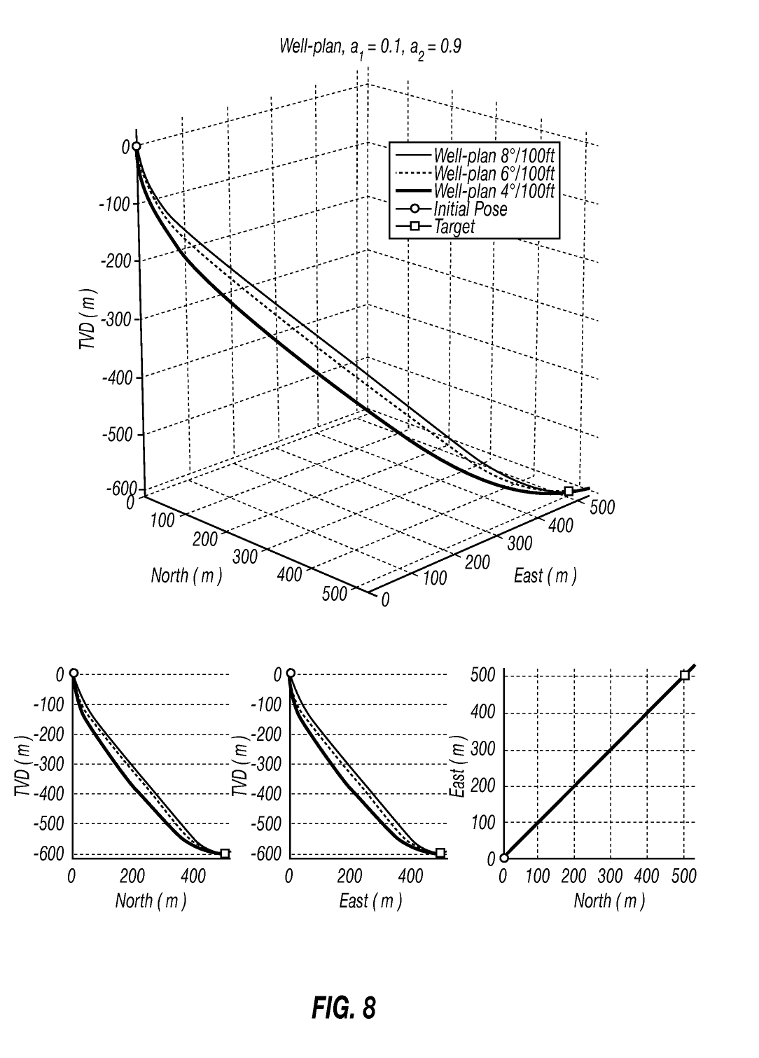

FIG. 8 shows the well plans created, in accordance with an embodiment of the present invention, for an initial pose of vertical to hit a target at a given attitude. Three different dogleg constraints were used. This well-plan was for minimum strain energy.

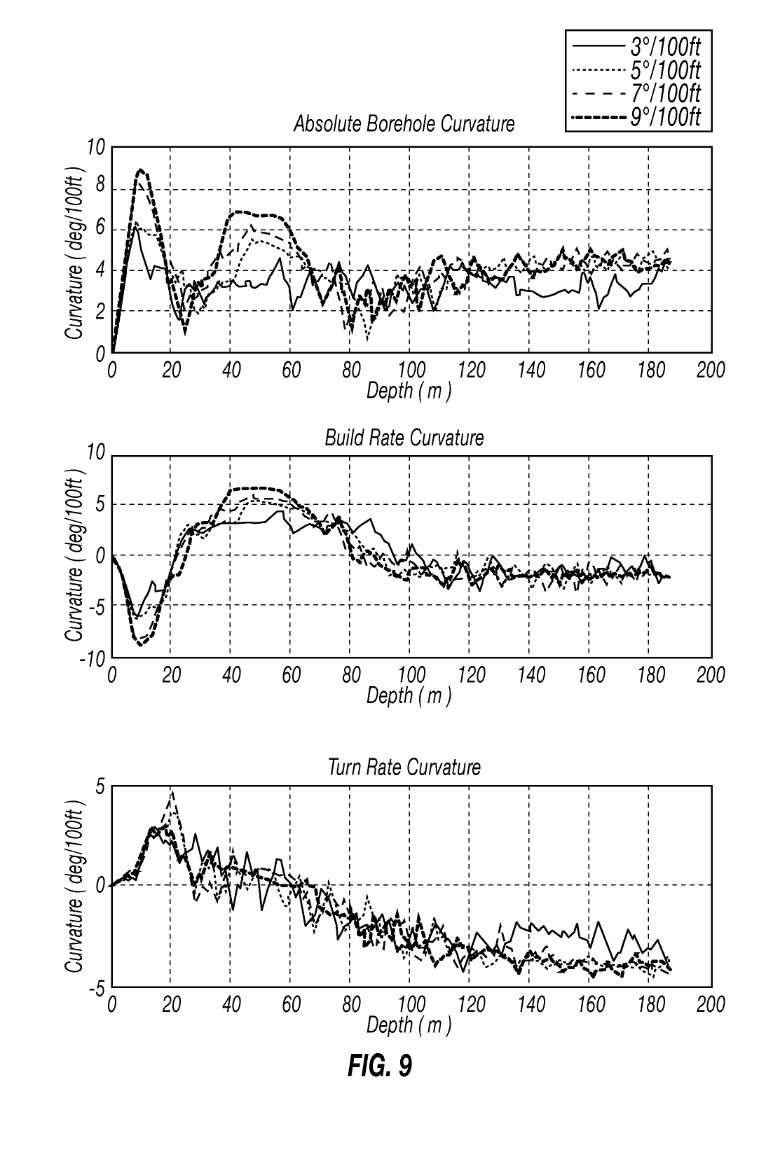

FIG. 9 shows the effect of the constraints on the curvature. It can be seen that the curvatures are higher at the start and end of the curves. It can be seen that when minimizing arc-length, the resultant curves have straight sections and large changes in curvature. When the minimum strain energy objective is imposed, the curves appear to be smoother since the changes in curvature are less abrupt and that the curvature is distributed more along the well-plan as the straight sections are less than that of minimum arc-length. It can also be seen that designing well-plans with higher curvature constraints give longer well-plans.

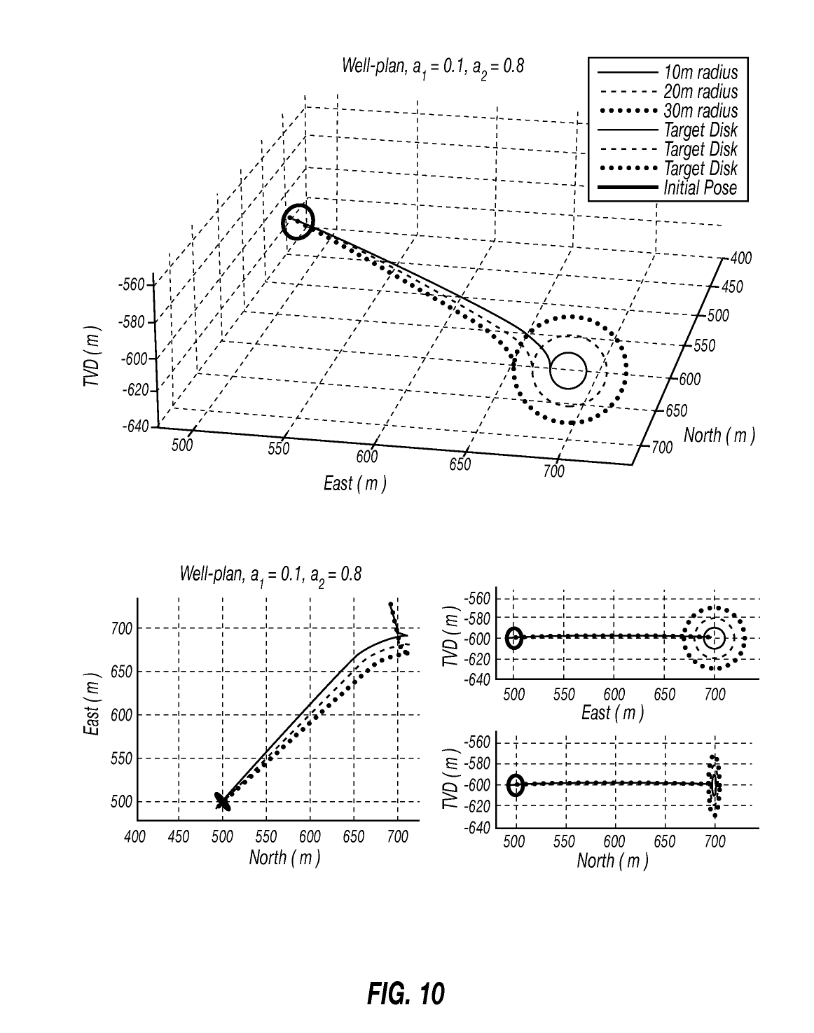

FIG. 10 takes the final position and attitude of the prior well plan to use as an initial pose for the next stage. The destination in this case is taken to be a target constraint. This target is a combination of a sphere, a point in plane and an attitude to strike the disk. The well-plan is planned for a dogleg of 8°/100 ft. Three different disk constraints are demonstrated. It can be seen that the optimization solves for the closest point in this disk to strike. Furthermore all curves strike the disk at the same attitude.

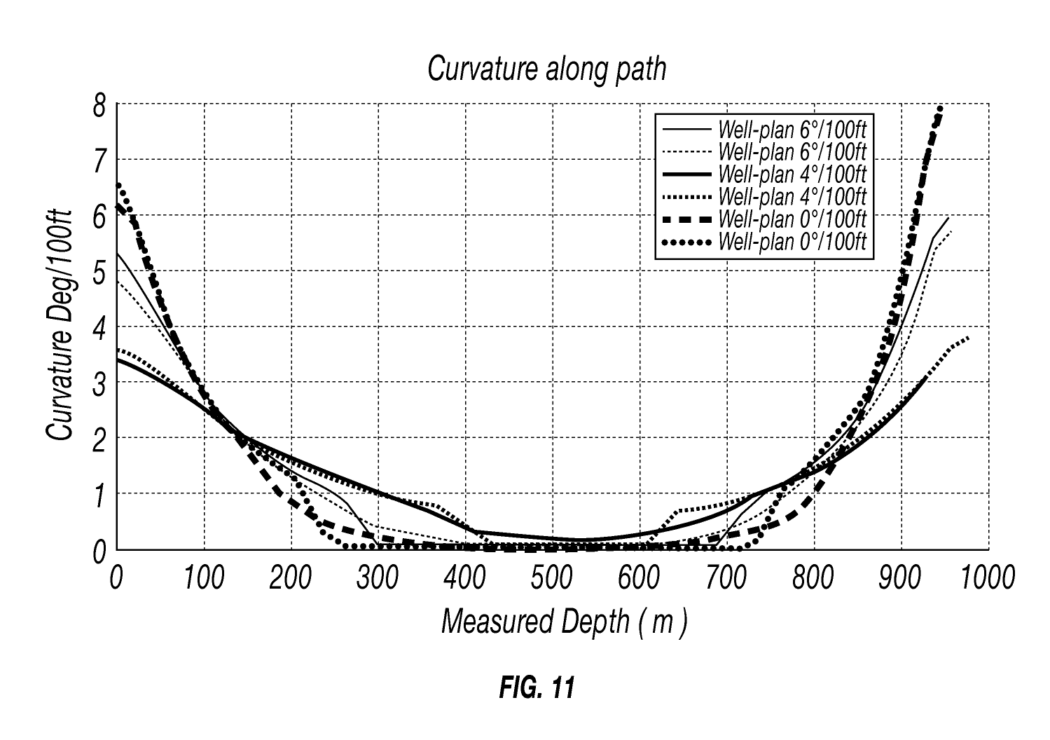

FIG. 11 shows simulated strain energy curves.

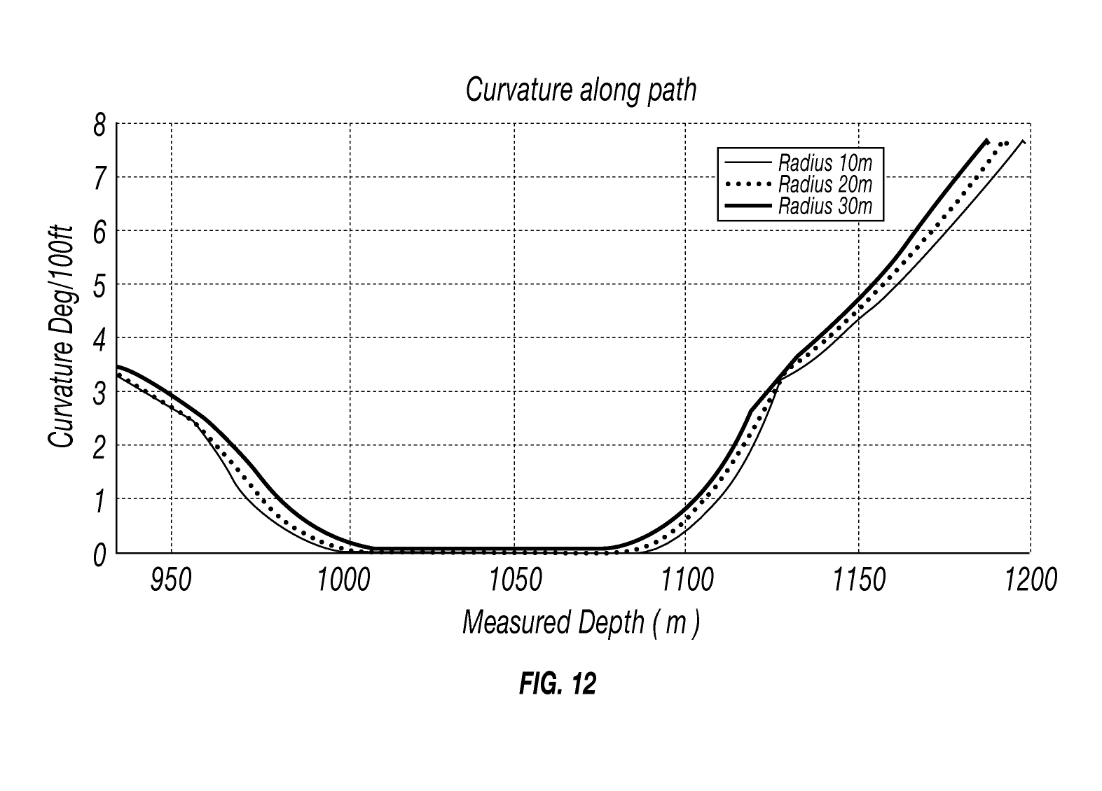

FIG. 12 shows the curvature along the well-plans. It can be seen that the higher the curvature constraint the longer the well-plan. It can also be seen that the curvature constraints are respected, and that there is straight hole section.

In some embodiments existing well plans and/or well plan segments can be combined or joined using embodiments of the invention. For example, existing well plan segments can be identified and joined in a way that minimizes strain energy within the well, minimizes torsion within the well, minimizes the arc-length within the well and/or uses convex optimization techniques

Moreover, in some embodiments an existing well plan can be modified using embodiments of the invention. For example, an existing well plan can be identified and modified in a way that minimizes strain energy within the well, minimizes torsion within the well, minimizes the arc-length within the well and/or uses convex optimization techniques

Well plans created using embodiments of the invention can be used for trajectory control purposes. For instance, well plans created using embodiments of the invention can be used to direct the drilling path of a drilling rig.

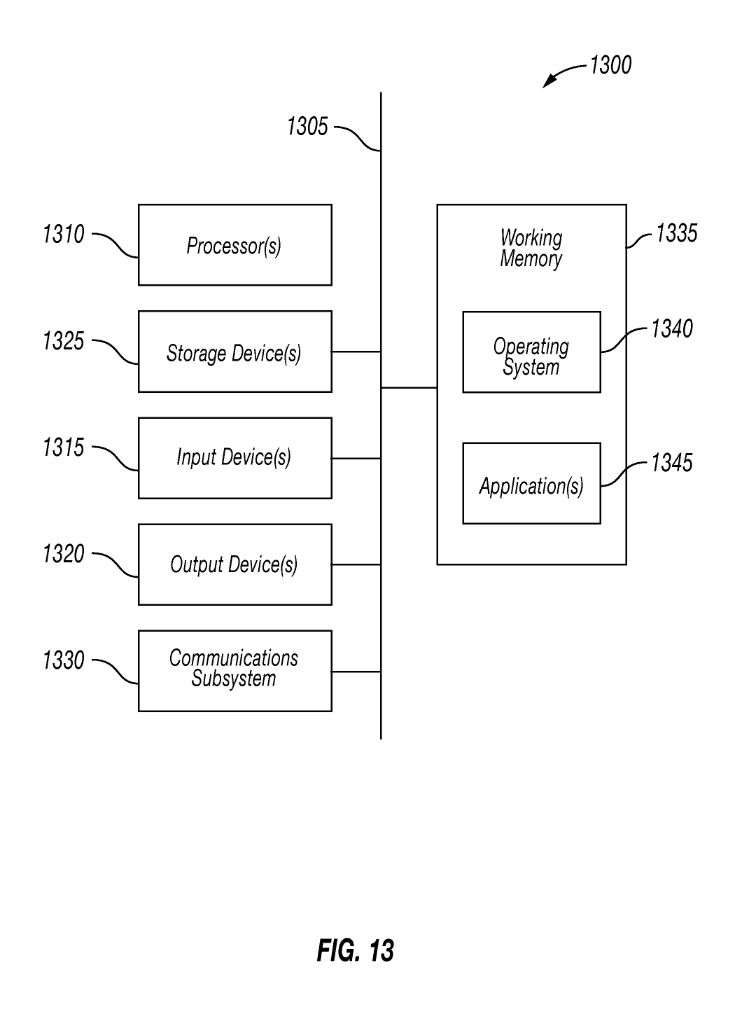

Some embodiments of the invention can be implemented using a computational system such as a server or computer system. An example of a computational system is shown in FIG. 13. In some embodiments multiple distributed computational systems can be geographically distributed. Moreover, various calculations, methods, and/or algorithms can be followed and/or solved using computation system 1300.

Computational system 1300 includes hardware elements that can be electrically coupled via a bus 1305 (or may otherwise be in communication, as appropriate). The hardware elements can include one or more processors 1310, including without limitation one or more general-purpose processors and/or one or more special-purpose processors (such as digital signal processing chips, graphics acceleration chips, and/or the like); one or more input devices 1315, which can include without limitation a mouse, a keyboard and/or the like; and one or more output devices 1320, which can include without limitation a display device, a printer and/or the like.

The computational system 1300 may further include (and/or be in communication with) one or more storage devices 1325, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 1300 might also include a communications subsystem 1330, which can include without limitation a modem, a network card (wireless or wired), an infrared communication device, a wireless communication device and/or chipset (such as a Bluetooth device, an 1302.6 device, a WiFi device, a WiMax device, cellular communication facilities, etc.), and/or the like. The communications subsystem 1330 may permit data to be exchanged with a network (such as the network described below, to name one example), and/or any other devices described herein. In many embodiments, the computational system 1300 will further include a working memory 1335, which can include a RAM or ROM device, as described above.

The computational system 1300 also can include software elements, shown as being currently located within the working memory 1335, including an operating system 1340 and/or other code, such as one or more application programs 1345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1325 described above.

In some cases, the storage medium might be incorporated within the computational system 1300 or in communication with the computational system 1300. In other embodiments, the storage medium might be separate from a computational system 1300 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 1300 and/or might take the form of source and/or installable code, which, upon compilation and/or installation on the computational system 1300 (e.g., using any of a variety of generally available compilers, installation programs, compression/decompression utilities, etc.) then takes the form of executable code.

Embodiments of the invention can be used for any type of trajectory control system. For example, embodiments of the invention can be used in UAV's mobile robots, remote control cars, remote control aircraft, etc.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A method for generating a geological well-plan comprising:
defining an initial pose of the well;
defining a sequence of destinations;
setting a steerability constraint;
setting a smoothness objective;
solving for an optimal well-plan from the initial pose to the first destination and then from destination to destination through the sequence of destinations, wherein the solving for the well-plan factors in the steerability constraint and the smoothness objective.

2. The method of claim 1, wherein:
the smoothness objective comprises minimizing strain energy within the well.

3. The method of claim 1, wherein:
the smoothness objective comprises minimizing torsion within the well.

4. The method of claim 1, wherein:
the smoothness objective comprises determining a well-plan that minimizes the arc-length within the well.

1. The method of claim 1, wherein:
the smoothness objective comprises determining a well-plan using convex optimization techniques.

2. The method of claim 1, wherein the well-plan is constrained to hit one or more of the following: a volume within a reservoir, a point within a volume, a plane within a reservoir, a specific azimuth, a tangent constrained in a volume, a convex constraint on tangent, and/or a specific inclination.

7. A method for designing a well-plan for a wellbore penetrating through an earth formation, comprising:
providing that the well-plan intersects with a series of one or more targets between a start location and a goal;
providing that the wellbore can be drilled and/or tracked by a directional drilling tool to be used to drill the wellbore; and
providing that the well-plan is continuous and at least one of smooth or satisfies a fairness criteria.

8. The method of claim 7, wherein the wellbore is designed to extend through a hydrocarbon reservoir in the earth formation and the series of one or more targets comprise volumes of high hydrocarbon saturation in the hydrocarbon reservoir.

9. The method of claim 7, wherein providing that the wellbore can be drilled and/or tracked by the directional drilling tool to be used to drill the wellbore comprises determining directional drilling properties of the drilling tool.

10. The method of claim 7, further comprising:
receiving an earth model for the earth formation and using the earth model to determine operating properties of the drilling tool.

11. The method of claim 7, wherein providing that the wellbore can be drilled and/or tracked by the directional drilling tool to be used to drill the wellbore comprises using prior information from operation of the drilling tool or a similar drilling tool.

12. The method of claim 7, wherein:
the well plan is designed to provide a smooth trajectory between the start location and a first of the series of one or more targets; and
an optimum curvature of the wellbore at the first of the series of one or more targets is used as a constraint for the well-plan between the first of the one or more targets and a second of the one or more targets.

13. The method of claim 7, wherein B-spline space curves are used to represent the well-plan.

14. The method of claim 7, wherein smoothness is processed by determining frictional resistance that would be produced by deploying a pipe having an outer-diameter in the wellbore.

15. The method of claim 14, wherein the frictional resistance is determined from the amount of bending of the pipe in the wellbore.

16. The method of claim 7, wherein smoothness is processed from the tortuosity of the wellbore and the tortuosity is defined by a strain energy that would be exerted on a pipe being deployed in the wellbore.

17. The method of claim 16, wherein the strain energy is determined from at least one of hole clearance around the pipe in the wellbore and torsion of the pipe in the wellbore.

18. The method of claim 7, wherein a minimum curvature method is used to design the wellbore between the start location and the goal and/or between targets in the series of one or more targets.

19. The method of claim 7, wherein a pose of the wellbore at the start location, the goal or the one or more targets is defined, and wherein the pose is defined as a position and an orientation of a pipe of a certain outer diameter disposed in the wellbore at the start location, the goal or the one or more targets.

20. A method for designing a well-plan for a wellbore penetrating through an earth formation, comprising:
determining a series of one or more targets between a start location and a goal, wherein the series of one or more target locations comprise volumes of high hydrocarbon deposits in the earth formation;
determining a curved trajectory between one of the: the start location and a one of the series of one or more targets, a first of the one or more targets and a second of the series of one or more targets
providing that the wellbore can be drilled and/or tracked by a directional drilling tool to be used to drill the wellbore; and
providing that the well-plan is continuous and at least one of smooth or satisfies a fairness criteria.

21. The method of claim 20, wherein series of locations between the start location and the goal are selected to provide for at least one of the following: segmentation of the path between the start location and the goal and positioning of at least one of the series of locations at boundaries between different rock types in the earth formation.

22. A system for designing a well-plan for a wellbore penetrating through an earth formation, comprising:
a processor configured to receive a start location and a goal in the earth formation and to execute instructions thereon, the instructions comprising:
determining a series of target locations between and including the start location and the goal;
configuring the well-plan between the start location and the goal, wherein:
the configured well-plan passes through each of the target locations in the series of target locations;
the configured well-plan is designed by processed sections of well-path between each of the series of targets;
the sections of well-path are processed by calculating a starting curvature of the wellbore at a first of the series of targets and designing a curve section between the first of the series of targets and second of the series of targets, wherein a curvature of the curve section is minimized using the starting curvature and drilling characteristics of a drilling to be used to drill the wellbore as constraints; and
at least one of storing or outputting the designed well-plan.

23. The system of claim 22, wherein minimizing the curvature of the curve between the first of the series of targets and the second of the series of targets comprises minimizing resistive forces acting on a pipe of a defined diameter deployed through the curve section.

24. The system of claim 22, wherein minimizing the curvature of the curve between the first of the series of targets and the second of the series of targets comprises minimizing a strain energy acting on a pipe of a defined diameter deployed through the curve section, and wherein the strain energy comprises bending forces acting on the pipe.

25. The system of any of claim 22, further comprising:
receiving an earth model for the earth formation and using rock properties to process the curvature of the curve section.

26. The system of any of claim 22, the processor instructions further comprising:
determining an overall curvature of the well-plan between the start location and the goal as provided by a combination of each of the processed sections of well-path;
minimizing the overall curvature and
reprocessing each of the processed sections of well-path using the minimized overall curvature as a constraint.
